(19) United States
(12) Patent Application Publication
(10) Pub. No.: US 2012/0111961 A1
(43) Pub. Date: May 10, 2012

(54) Grove sprayer

(76) Inventor: James R. Arnold, Clermont, FL (US)

(21) Appl. No.: 12/927,131

(22) Filed: Nov. 9, 2010

(51) Int. Cl. B05B 9/04

(52) U.S. Cl. 239/1; 239/373

(57) ABSTRACT

A fogging grove sprayer has a nozzle enclosing housing having at least one outlet therefrom and encloses a plurality of air sheer nozzles using compressed air to atomize a spray solution which is dispensed into the housing. Each air sheer nozzle has a liquid under pressure and high pressure air to generate a fog in the housing. A high velocity, high volume fan forces air into the housing and disperses the spray from the nozzles in the housing out the housing outlets. A method of spraying a grove with fogging spray uses the apparatus to spray a chemical fog onto tree foliage

### BACKGROUND OF THE INVENTION

The present invention relates to a grove sprayer and especially to a grove sprayer using air sheer nozzles using compressed air to atomize a spray solution to create a fog-like dispersal of liquid chemicals into a containment housing which chemical fog is dispersed into the atmosphere with a high velocity, high volume fan to obtain improved coverage of tree foliage.

The application of treatment chemicals, such as insecticides, fungicides and the like, to trees planted in a grove has been widely practiced for protection of the trees. Insects and fungi tend to congregate on the leaves of the trees, especially on the underside of the leaves. To get better coverage of chemical spray on the foliage, fans or blowers are used which direct an open stream of air at high velocity across spray nozzles dispersing liquid chemicals into the tree foliage. The air stream rustles the leaves for a more uniform coverage of the leaves of the trees with the treatment of chemicals.

In the past, there have been a wide variety of agricultural sprayers which generally are drawn by tractors, trucks or the like for spraying of liquid chemicals. Generally, prior art sprayers have large propellers or a number of propellers which create an air flow which carries the chemicals to the foliage. This type of prior art sprayer uses large amounts of chemical spray and does not always provide full or uniform coverage of the tree foliage. In addition, these sprayers generally spray at random while the trees vary in size, shape and distance between trees, requiring larger amounts of chemical sprays which increases the costs of spraying the trees while wasting chemicals and dispensing excess chemicals into the environment.

The present invention is directed towards reducing the amount of spray while obtaining better coverage of the foliage of trees in a grove. This is accomplished by producing a fog of very fine chemical spray using air sheer nozzles into high velocity, high volume air from a separate blower driving the fogged spray into the foliage.

In one prior U.S. Pat. No. 5,522,544 to Gal, an orchard or grove sprayer has a rigid tubular member housing nozzles for discharging chemicals into flexible upper and lower sleeves secured to a rigid member. The upper sleeve has air discharged thereinto from a blower which lets the air escape through openings in the flexible sleeves along with chemicals in the sleeves. The Lenhardt U.S. Pat. No. 4,347,978 is an agricultural sprayer for use in orange groves or orchards which utilizes a high velocity, high volume axial flow fan to direct air through a plenum chamber where the air is divided to flow towards opposed lateral openings at the sides of the sprayer. It also has an oscillator for directing the flow of air.

A combination aerosol generator and thermal fogger is shown in U.S. Pat. No. 6,032,407 to Conner. This patent has a thermal fogger for dispensing a mosquito killing insecticide which is generated with an engine exhaust and has a separate aerosol nozzle for dispensing the insecticide. A flow selector valve determines which discharge device receives the insecticide.

The present invention combines air sheer nozzles to produce a fog within a rigid housing and has a high volume fan or blower supplying turbulence to the inside of the housing to further direct the fog created therein through outlets and onto tree foliage for a more even distribution of the chemicals being sprayed and a more even coverage of the foliage while using a smaller amount of chemicals.

### SUMMARY OF THE INVENTION

A fogging grove sprayer has a nozzle enclosing housing having at least one outlet therefrom for enclosing a plurality of air sheer nozzles for dispersing a fogged liquid in the housing and towards the outlets from the housing. The sprayer has a liquid supply tank for supplying an insecticide or the like and a liquid pump connected to the supply tank and to each of the plurality of nozzles for supplying a liquid from the supply tank to each of the plurality of nozzles in the nozzle enclosing housing. An air compressor is connected to each of the nozzles for supplying compressed air to each of the nozzles for atomizing the liquid into a fog as it is dispersed from the plurality of nozzles. Each nozzle receives a liquid under pressure which is then sheered with a vortex of compressed air to form the fog spray within the housing. A high volume fan, which may be an axial fan or a centrifugal blower, is connected to the housing to force air into the housing for dispersing the atomized liquid in the housing out the outlets therefrom to widely disperse a fogged liquid into tree foliage. Six or twelve or any number of air sheer nozzles can be utilized, each being connected to a compressed air plenum having air compressed by an air compressor. The plenum may be an arcuate shaped plenum within a housing.

A method of spraying a grove includes selecting a grove sprayer in accordance with the present apparatus, pumping a liquid from the liquid supply tank to each nozzle for dispersal therefrom into the housing with the air from an air compressor which passes through each nozzle to atomize the liquid. The atomized liquid is then dispersed through the outlet in the housing with air from a high volume fan or blower which disperses the spray out the housing outlet.

### BRIEF DESCRIPTION OF THE DRAWINGS

Other objects, features, and advantages of the present invention will be apparent from the written description and the drawings in which:

FIG. 1 is a side sectional view of a grove sprayer in accordance with the present invention taken on the line 1-1 of FIG. 2;

FIG. 2 is a sectional view of the grove sprayer housing of FIG. 1 taken on line 2-2 of FIG. 1;

FIG. 3 is a partial sectional view of an alternate embodiment of the housing having the air sheer nozzles mounted through to the housing;

FIG. 4 is an exploded view of the high volume rotary fan and the air sheer nozzles and the containment housing;

FIG. 5 is an alternate embodiment of a grove sprayer of the present invention having a squirrel cage blower;

FIG. 6 is a side sectional view of an air sheer nozzle in accordance with the present invention; and

FIG. 7 is a top sectional view of the nozzle of FIG. 6.

### DETAILED DESCRIPTION OF THE PREFERRED EMBODIMENT

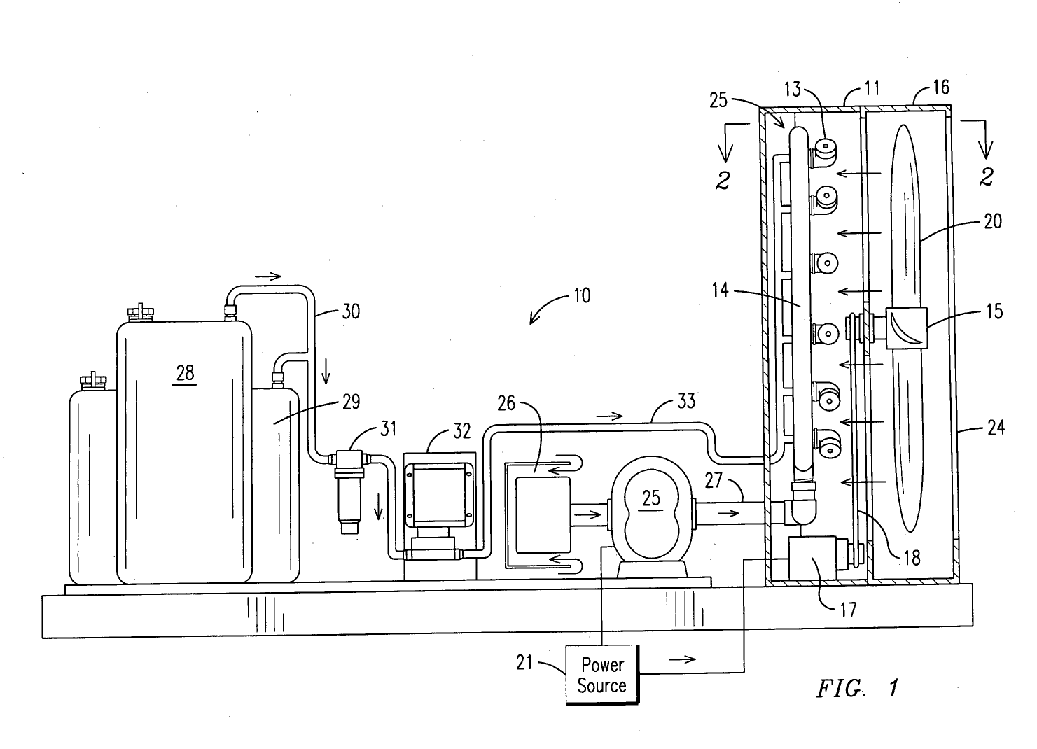

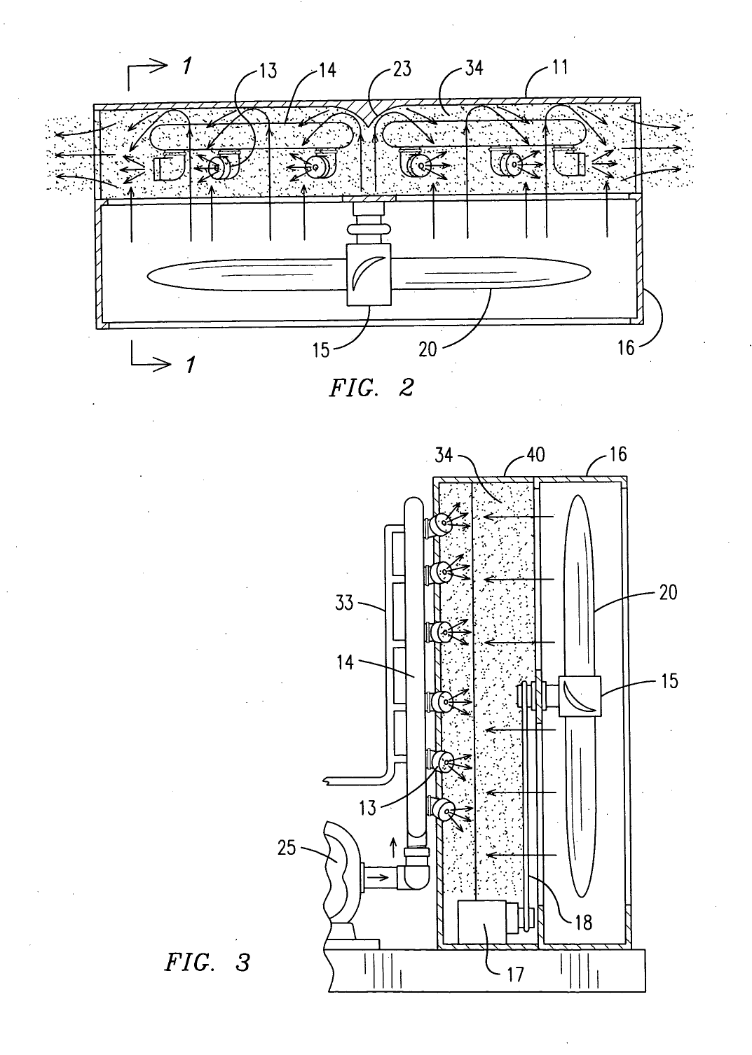

Referring to the drawings of FIGS. 1 and 2, a fogging grove sprayer 10 has a containment and diverter box housing 11 having a plurality of air sheer or air assist nozzles 13 which are attached to a compressed air plenum 14. A high volume fan 15 is contained in an air containment box 16 and is driven by an electric motor 17, or other power source as desired, driving a belt 18 to rotate the fan blades 20. The electric motor 17 is connected to an electric power source 21, as seen in FIG. 2. The housing 11 has outlets 22 on both sides thereof and has a ridge 23 for directing the high volume fan 15 air being drawn through the opening 24 directly around the plurality of air sheer nozzles 13. The nozzles may direct the fogged liquid towards the outlets 22 or directly into the high volume of compressed air. The compressed air plenum 14 is fed compressed air from an air compressor 25 which is driven by an electric motor or other power source. The compressor 25 draws air into the opening 26 which air is compressed and fed through the air pipes 27 to the plenum 14. The sprayer receives the liquid supply from the chemical solution tanks 28 and 29 through tubes 30, which tubes are fed through a solution filter 31. The solution may be an insecticide, a fungicide or any other chemical solution desired.

The solution is supplied through the pump line 30 to the electric pump 32 which supplies the solution under pressure through the line 33 to each of the air sheer nozzles 13. The pump 32 can be a diaphragm, centrifugal, or peristaltic pump driven by any power source desired, such as a diesel or gasoline engine. The air sheer nozzles disperse the liquid solution under pressure into the housing 11 using the high pressure air from the air pump 25 passing through the same nozzles to produce a fog or very fine atomized liquid. This is a fogging sprayer at this point. The fog is dispersed in the housing 11 where a high velocity, high volume air blower 20 drives a high volume of air into the housing 11 towards the outlets 22. The air is diverted by the ridge 13 to produce air turbulence within the housing 11 and fog 34, as seen in FIG. 2. The air from the high volume fan 15 drives the finely atomized fog 34 out the outlets 22. The fan 15 directs the fogged liquid 34 through the outlet 22 and into tree foliage on either side of the sprayer 10. The output from the sprayer has sufficient force to disperse the fog throughout the foliage for a superior coverage and coating of the foliage leaves. The foliage coating is evenly done without wasting chemicals with an uneven coating of the foliage.

In operation the grove sprayer 10 pumps a solution from the supply tank 28 and 29 through the lines 30 with the liquid pump 32 which drives the chemical solution under pressure through the line 33 to each sheer nozzle 13. Simultaneously, the compressor 25 is drawing air through the openings 26, compressing the air into a line 27 and into the air plenums 14. This high pressure air in the plenum 14 passes through the nozzle to produce a vortex of fog from each nozzle into the housing 11. A high velocity, high volume fan or blower 20 drives the fogged spray through the outlets 22 and into tree foliage being treated. The sprayer finely coats the foliage to evenly treat the foliage for insects or fungi or the like.

Turning to FIG. 3, an alternate embodiment is illustrated of a containment or diverter box housing 40 having the blower 15 in the fan containment box 16 and having the plurality of nozzles 13 mounted on the air plenum 14. Each air assist or air sheer nozzle 13 is coupled to the solution supply line 33. In this embodiment, the plenum 14 is mounted outside the housing 40 and the air nozzles extend through openings in the housing 40 for dispersing a fogged spray 34 thereinto. The high velocity, high volume fan 15 drives air directly at the nozzles 13 to supply turbulence and to disperse the fog 34. Fan 15, in this embodiment, may also be driven by an electric motor 17 through a fan belt 18.

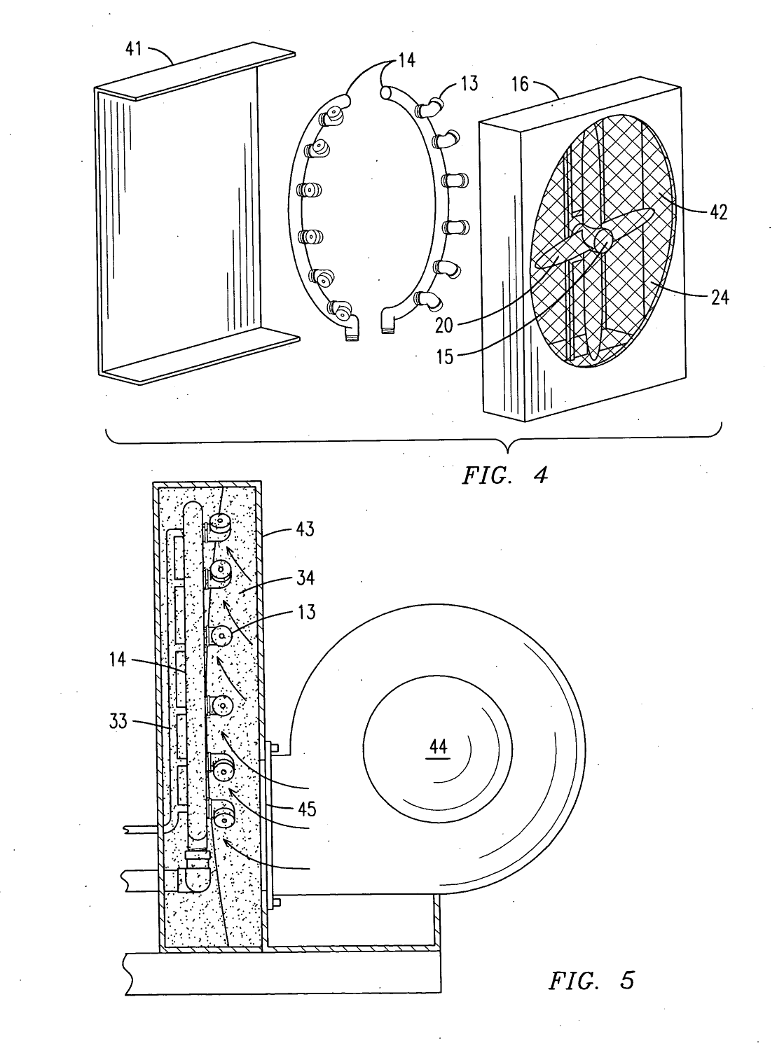

In FIG. 4, a containment box housing 41 is shown in exploded view with two compressed air plenums 14 exploded therefrom. Each air plenum 14 has a six air sheer nozzle 13 attached thereto. In this case, each air sheer nozzle 13 is mounted to one plenum 14. Each plenum has an arcuate shape forming a generally oval shape inside the housing 41. The high volume fan 15 is shown mounted in a housing 16 and has a plurality of fan blades 20. The fan blades 20 are shown covered by a grill 42 extending over the opening 24.

In FIG. 5, an alternate embodiment has the fog containment box or housing 43 having the plenums 14 and the plurality of air sheer nozzles 13 therein. The air sheer nozzles 13 are mounted to the compressed air plenum 14. Each nozzle is connected with the solution feed line 33. This embodiment has a squirrel cage blower 44 directing air through an opening 45 to drive the atomized solution 34 out openings in the housing 43.

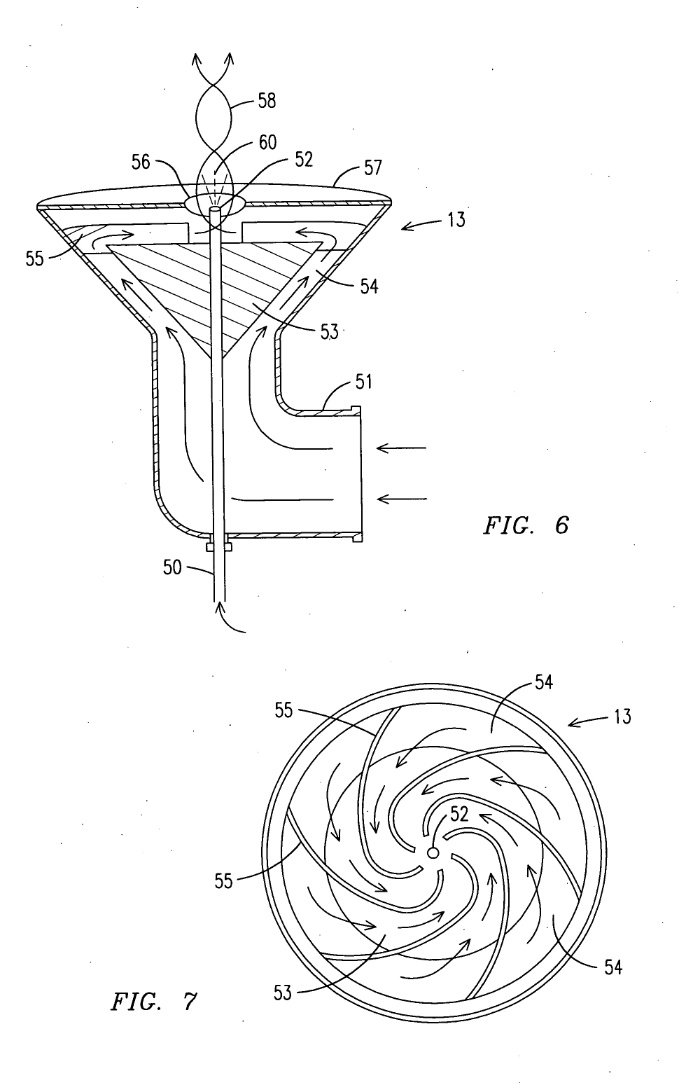

Referring to FIGS. 6 and 7, the air sheer nozzle 13 is illustrated connected to a liquid injection tube 50 and to a compressed air inlet tube 51. The liquid injection tube 50 passes through the nozzle 13 to the dispersion outlet 52. The pressurized air entering the inlet 51 is directed by a divider cone 53 to form a conical passageway 54 passing therearound. The air then passes through a plurality of curved ribs 55 which spirals the high velocity air forming a vortex around the outlet 52. The air exits the opening 56 in the face plate cover 57 of the nozzle 13. The arrows 58 illustrate the air exiting the nozzle in a vortex pattern as it sheers the spray exiting the injection tube 50 outlet 52. The use of the forced air in the air nozzle 13 forming a swirling or vortex pattern as it sheers across the outlet 52 dispersing the spray and atomizes the liquid spray and produces a fogging spray which is then directionally dispersed into the adjacent foliage by the high velocity, high volume fan 15.

It should be clear at this time that a fogging-type grove or agricultural sprayer has been provided which combines a fog generating sprayer with a high velocity, volume fan or blower for driving a fogged chemical solution, such as an insecticide or fungicide, into the foliage of a grove tree. A plurality of air sheer nozzles have been utilized to better produce the fog. The number of nozzles can be varied and can be a 12, as shown in FIG. 4, or a single air plenum 14 can have six nozzles. However, the present invention is not to be construed as limited to the forms shown which are to be considered illustrative rather than restrictive.

I claim:

1. A fogging grove sprayer comprising:
a nozzle enclosing housing, said housing having at least one outlet therefrom;
a plurality of air sheer nozzles mounted in said housing for dispersing a liquid into said housing;
a liquid supply tank;
a liquid pump connected to said liquid supply tank and being connected to each of said plurality of nozzles for supplying said liquid to each of said plurality of nozzles for dispersion therefrom;
an air compressor connected to each of said plurality of nozzles for supplying compressed air to each said nozzle for atomizing liquid from said supply tank being dispersed from each of said plurality of nozzles; and
a high velocity, high volume fan operatively connected to said housing to force air into said housing for dispersing the atomized liquid in said housing out said at least one outlet;
whereby a fogging sprayer can widely disperse an atomized liquid into a surrounding grove.

2. The fogging grove sprayer in accordance with claim 1 having a plurality of liquid supply tanks connected to said pump.

3. The fogging grove sprayer in accordance with claim 2 having an electric motor driving said high volume fan.

4. The fogging grove sprayer in accordance with claim 2 in which said high volume fan is a squirrel cage blower.

5. The fogging grove sprayer in accordance with claim 2 in which said plurality of nozzles includes at least six nozzles.

6. The fogging grove sprayer in accordance with claim 2 in which said plurality of nozzles includes at least twelve nozzles.

7. The fogging grove sprayer in accordance with claim 2 in which said plurality of nozzles are supported in said housing on an air plenum, said air plenum being supplied compressed air from said air compressor for said plurality of nozzles.

8. The fogging grove sprayer in accordance with claim 7 in which air plenum, supports said air nozzles in a generally arcuately in said housing.

9. The fogging grove sprayer in accordance with claim 8 in which said housing has at least two outlets, one opening on each two side thereof.

10. A method of spraying grove comprising:
selecting a grove sprayer having a nozzle enclosing housing having an outlet therefrom and having a plurality of air sheer nozzles mounted therein for dispersing a liquid into said housing, said grove sprayer having a liquid supply tank and a pump connected thereto for supplying said liquid to each of said plurality of nozzles for dispersal from each said nozzle into said housing, said grove sprayer having an air compressor connected to each of said plurality of nozzles for supplying compressed air to each nozzle for atomizing liquid from said supply tank being dispersed from each of said plurality of nozzles and said grove sprayer having a high volume fan operatively connected to said housing to force air into said housing for dispersing a fog in said housing out said outlet;
pumping a liquid from said liquid supply to each said nozzle for dispersal therefrom into said housing; forcing air from said air compressor into each said nozzle to generate the fog being dispersed therefrom;
dispersing said generated fog through said outlet in said housing with air from said fan into a surrounding grove;
whereby a grove has a fog dispersed thereinto.
